(19) United States
(12) Patent Application Publication
(10) Pub. No.: US 2003/0126220 A1
(43) Pub. Date: Jul. 3, 2003

(54) Quick reply codes for communication of information between electronic devices

(76) Inventor: James Wanless, Devon (GB)

Correspondence Address: James Wanless, c/o Solvware Information Technologies Inc., Suite 200 West Entrance, 1300 Don Mills Road, Toronto, ON, M3B 2W6, CA

(21) Appl. No.: 10/326,421

(22) Filed: Dec. 23, 2002

Related U.S. Application Data
(60) Provisional application No. 60/343,671, filed on Dec. 27, 2001.

(51) Int. Cl. G06F 15/16

(52) U.S. Cl. 709/206

(57) ABSTRACT

A method of processing information between electronic devices in which quick, numeric reply codes are used. The same code may be used repeatedly in connection with the processing of information through multiple processes and devices creates a unique usability aspect to unified messaging communications.

### REFERENCE TO CO-PENDING APPLICATIONS

The entire subject matter of U.S. Provisional application serial No. 60/343,671 filed Dec. 27, 2001 and entitled QUICK REPLY CODES FOR COMMUNICATION OF INFORMATION BETWEEN ELECTRONIC DEVICES is incorporated by reference. The applicant claims priority benefit under Title 35, United States Code, Section 119(e) of U.S. Provisional application serial No. 60/343,671 filed Dec. 27, 2001 and entitled QUICK REPLY CODES FOR COMMUNICATION OF INFORMATION BETWEEN ELECTRONIC DEVICES.

### BACKGROUND OF THE INVENTION

1. Field of the Invention

This invention relates to a method of processing information between electronic devices. More particularly, it relates to the use of quick reply codes in the communication of information between electronic devices.

2. Background of the Invention

Information processing systems typically involve the assignment of a unique identification number called the Global User Identification (“GUID”) number to each item or bundle of information. This number is so long that it would be impossible for a normal user to remember. In addition, the GUID number is alphanumeric. Therefore, when using a standard telephone keypad where it is not possible to enter anything other than digits, the GUID number doesn't work. It would therefore be desirable to provide an alternative information processing system that uses numeric identification numbers, whether short or long, instead of or in addition to GUID numbers.

### SUMMARY OF THE INVENTION

The concept of an easy to remember number to be used repeatedly in connection with the processing of information through multiple asynchronous, stateless processes creates a unique usability aspect to unified messaging communications. A method of processing information between electronic devices comprises the steps of:

assigning a unique numerical identification code to any item from an individual's personal information store;

linking the numerical identification code to the item for its complete lifecycle throughout a network;

notifying the user of the numerical identification code;

performing at least one network functional operation on the item by reference to

the identification number;

deleting the item; and,

after the item has been deleted, releasing the numerical identification code.

The step of performing at least one network functional operation means performing a function selected from the group consisting of: sending E-Mail, replying to email, forwarding email, replying to a text message using SMS, forwarding a text message using SMS, replying to message by voice using a telephone replying to message by voice using a telephone, forwarding to a fax machine for a print copy; requesting selected pieces by SMS to be sent to the mobile device; delaying further notification until a time in the future; and, retrieving text of tasks.

It is an object of the present invention to provide a method of processing information between electronic devices using Quick Reply codes that are numeric (unlike alphanumeric GUID numbers).

### BRIEF DESCRIPTION OF THE DRAWINGS

FIG. 1 shows a block diagram of the steps in the method of communicating information between different electronic devices using quick reply codes, which may be used in one embodiment of the present invention.

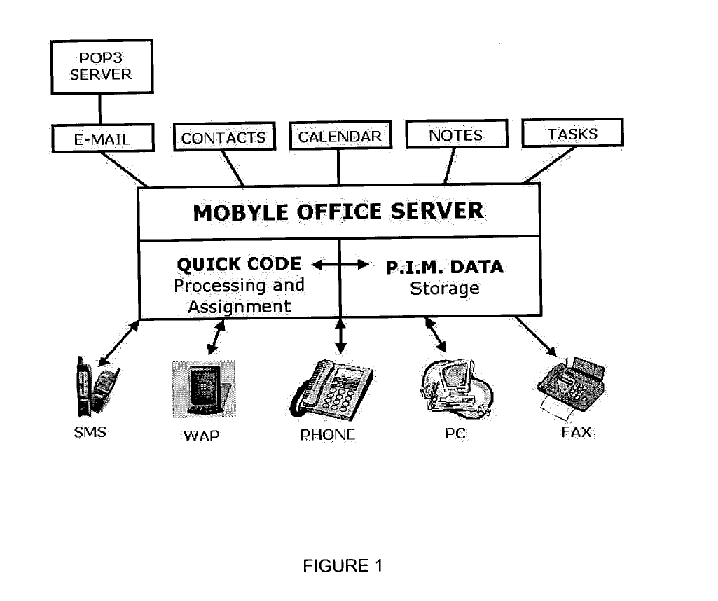

### DETAILED DESCRIPTION OF THE INVENTION

Quick reply codes is the assignation of a unique 4-digit identification number to any item from an individual's personal information store. This number is linked to an item for its complete lifecycle throughout the Talkster Mobyle Office network. Although GUID numbers are the underlying reference method that the present invention uses to identify an item once inside the Mobyle Office Server, the 4-digit identification number assigned to the item is used to retrieve and process the item from any access device whether local or remote. The concept of an easy to remember number to be used repeatedly in connection with the processing of information through multiple processes and devices creates a unique usability aspect to unified messaging communications.

The Process

An item is received into a user's personal data store. This data is commonly referred to as P.I.M. data, which is an acronym for Personal Information Management Data. Data can be any of the following items: e-mail; appointment or other calendar item; contact or address book entry; task entry; note.

The Talkster Mobyle Office Server assigns a unique 4-digit code to the new or modified item. The 4-digit number is assigned sequentially beginning at 0000. This means that the system looks at the lowest available code beginning with 0000. If an item with the code 0012 is deleted then a new item being received would be assigned that code as it is the lowest number available. 4-digit codes are assigned dependant on the type of item. There can be a mail item 0000 and also a contact 0000.

The server uses database technologies to index and find the first available in the series.

Once an item is deleted the code is released for use by newly received items. As soon as it is released (on removal or deletion of an item) it is available to be re-assigned.

A user becomes aware of the item and its associated 4-digit code by one of the following methods:

1. Item is viewed through a WEB browser interface;

2. Notification of the newly received item is sent to the user's mobile device as a text message;

3. User requests the item from their mobile device based upon input search criteria and is sent the matching item to their mobile device.

Users can access the data and individual items using any of the following devices:

1. a computer with and Internet Link and a WEB browser;

2. a cellular telephone or other device equipped with a mobile browser. These devices are commonly referred to as WAP (Wireless Application Protocol) devices;

3. a cellular telephone equipped with the capability to send and/or receive text messages. The sending and receipt of text messages is commonly referred to as SMS (Short Messaging Service);

4. any telephone using standard voice capabilities.

Once an item has been viewed or the user has become aware of the Quick Reply code associated with an item, then they can perform a variety of actions using the Quick Reply code as the reference. The functions are dependent on the properties of the item and are grouped as follows:

E-Mail

Reply and/or forward by text using SMS

Reply and/or forward by voice using any telephone

Forward to a fax machine for a print copy

Request selected pieces by SMS to be sent to the mobile device

Contact or Address Book Item

Send an e-mail to the contact's e-mail address as text using SMS

Initiate the sending of a talking e-mail to the contact's e-mail address using SMS

Using any telephone, record the voice message to be attached to the talking email initiated by SMS.

Appointment or other Calendar Item

a. Delay further notification until a time in the future (commonly referred to as “snooze”)

Retrieve additional content of the item in the body of the item.

Notes

Retrieve text body of the item

Tasks

Retrieve the text of the item

It will be apparent that the scope of the present invention is limited only by the claims set out hereinbelow.

What is claimed is:

1. A method of processing information between electronic devices comprising the steps of:
assigning a unique numerical identification code to any item from an individual's personal information store;
linking the numerical identification code to the item for its complete lifecycle throughout a network;
notifying the user of the numerical identification code;
performing at least one network functional operation on the item by reference to the identification number;
deleting the item; and,
after the item has been deleted, releasing the numerical identification code.

2. The method of claim 1 wherein the least one network functional operation is selected from the group consisting of: sending E-Mail, replying to email, forwarding email, replying to a text message using SMS, forwarding a text message using SMS, replying to message by voice using a telephone replying to message by voice using a telephone, forwarding to a fax machine for a print copy; requesting selected pieces by SMS to be sent to the mobile device; delaying further notification until a time in the future; and, retrieving text of tasks.
